(19) United States
(12) Patent Application Publication
(10) Pub. No.: US 2012/0084810 A1
(43) Pub. Date: Apr. 5, 2012

(54) System and Method for Integrating Interactive Region-Based Advertising Into Real Time Video Content

(76) Inventors: Mark Thompson, Tempe, AZ (US); Earl Cole, Santa Monica, CA (US)

(21) Appl. No.: 13/252,555

(22) Filed: Oct. 4, 2011

Related U.S. Application Data
(63) Continuation-in-part of application No. 13/247,697, filed on Sep. 28, 2011.
(60) Provisional application No. 61/404,393, filed on Oct. 4, 2010.

(51) Int. Cl. H04N 21/40

(52) U.S. Cl. 725/34

(57) ABSTRACT

A system and method for interactive video advertising comprising advertising overlays displayed on a video screen to prompt user interaction. Advertising overlays directly and substantively relate to video content and promote advertising content. Advertising overlays highlight a particular region of the video content for which an advertiser wishes to promote user interaction. Such overlays notify the user that a particular portion of the video content is related to advertising content that may be stored and viewed in a user interface.

### CROSS-REFERENCE TO RELATED APPLICATIONS

This application incorporates by reference and claims priority to Provisional Patent Application Ser. No. 61/404,393 filed Oct. 4, 2010, and is a Continuation in Part of patent application Ser. No. 13/247,697 filed Sep. 28, 2011, titled “System and Method for Integrating Interactive Advertising Into Real Time Video Content,” all commonly owned.

### FIELD OF THE INVENTION

The present invention is directed toward a system and method for video advertising. More specifically, the invention relates to an in-video advertising interface that allows viewers to react to advertising impressions in real-time.

### BACKGROUND OF THE INVENTION

Targeting video advertisements to appropriate demographics remains a challenge to the advertising field. Video advertisements, whether on traditional television or through streaming internet content, typically force viewers to watch advertisements that are not relevant for individual viewers. Such advertisements fail to efficiently reach intended audiences.

For interactive content, viewers who click on in-program advertising are typically immediately taken away from such content which is a disincentive to engage interactive advertising, therefore effectively minimizing the efficacy of advertising efforts. Advertisements on YouTube™, for example, may be clicked during video content, but immediately remove the user from the video content being viewed in order to follow what is effectively an internet hyperlink that leads to alternate content. This is a severe disincentive for users to click on advertisements.

Other forms of video advertising, such as those by GoDaddy.com, are mere suggestions which refer a viewer to visit a website to further view additional advertising content. This necessitates that a viewer record or memorize website addresses to be inputted by the user into a computer system at a later date. This advertising mechanism suffers from numerous disadvantages. Specifically, it relies on a viewer's memory and forces the viewer to undergo a large number of discrete steps such as accessing a computer, opening a web browser, entering link information, and navigating the internet to view advertising content. Additionally, viewers may remain anonymous which is a disadvantage to advertisers who attempt to collect viewer data.

Other advertisers have created interactive video advertising systems that allow advertisements to be accessed from a user interface, yet suffer from the limitation that a user must have a specific digital video recordation device to view such content. Furthermore, these advertisements only originate in advertising content, and there is a need in the advertising marketplace to place interactive advertisements in featured video content.

Accordingly, there is a need for advertisers to both personalize advertising to qualified target demographics while increasing ciickthrough rates for interactive video advertising so as to maximize an advertiser's return on investment. Specifically, there is a need for a system that minimizes content interruption while gathering relevant personalized consumer data so that relevant advertisements reach relevant audiences through video, internet, mobile, social media, and traditional advertising vehicles.

### SUMMARY OF THE INVENTION

This invention is directed to a system and method for region-based interactive video advertising which may comprise a video display capable of displaying video content. An advertisement tag substantively relates to the video content and prompts a user interaction may be displayed concurrently with video content. In one embodiment, the advertisement tag is a relational tag that substantively relates to at least one of a product, service, song, person, scene, and location, and notifies the user that related advertisement material may be saved for viewing in an advertising cart user interface. The relational advertisement tag may be a photographic representation, icon, logo, textual representation, menu, audible cue or a combination thereof. The advertisement tag may contain embedded metadata.

In another embodiment, an advertisement tag may be referred to as a regional tag, as it regionally relates to the video content and prompts for user interaction. The regional advertisement tag notifies the user that at least one of a product, service, person, scene, and location is related to advertising that may be saved for viewing in an advertising cart user interface. The regional advertisement tag is at least one of a highlighted region, boxed region, circumscribed region, flashing region, tactile notification, and audible notification. The regional advertisement tag may contain embedded metadata. If the video content is dynamic, the regional advertisement tag may be dynamic, and may track the path of a particular image within the video content.

A registry of interaction history is stored in an interaction history archive in the form of an advertising cart user interface that is populated with interaction history data and is a storage site for interaction history. An advertisement positioning algorithm may review and prioritize the interaction history created by a user acknowledgment of the advertisement tag. Probabilistic market segmentation analysis results in the displaying of advertising content based upon the interaction history.

The system may automatically send at least one of advertising content, video content viewing suggestions, purchase recommendations, and data to other users, other user interfaces, and social networks. A user may utilize controls in the user interface to send at least one of advertising content, video content viewing suggestions, purchase recommendations, and data to other users, other user interfaces, and social networks.

The invention also encompasses a method for interactive video advertising which is a series of steps, including in one embodiment the displaying of content on a video display wherein an advertisement tag is displayed in conjunction with the video content, the relating of the advertisement tag substantively with the video content, the interacting with the video display thereby populating an interaction history archive with a record of such interaction, the associating of the record of interaction with advertising content, the prioritizing of the advertising content based on user preferences, user history, advertising data, marketing parameters, market segmentation analysis, or combinations thereof, the displaying of the prioritized advertising content in a user interface, the accessing of the user interface in order to adjust user interface settings or controls, and the distributing of the advertising data to other individuals or networks.

The relating of the video content with the advertisement tag may comprise at least one of regionally highlighting, regionally boxing, regionally circumscribing, regionally flashing, tactilely indicating, and audibly indicating a relationship between the advertisement tag and a particular region of the video content.

### BRIEF DESCRIPTION OF THE DRAWINGS

For a fuller understanding of the invention, reference is made to the following detailed description, taken in conjunction with the accompanying drawings illustrating various embodiments of the invention:

FIG. 1 is a flow chart showing the major components of the advertising system;

FIG. 2 is a flow chart showing one embodiment of the viewer profile creation scheme;

FIG. 3 is a flow chart showing one embodiment of the interactive advertisement system;

FIG. 4 is a flow chart showing the major components of the region-based advertisement selection system; and

FIG. 5 is a flow chart showing one embodiment of the region-based advertisement selection system.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

### Overview of the System

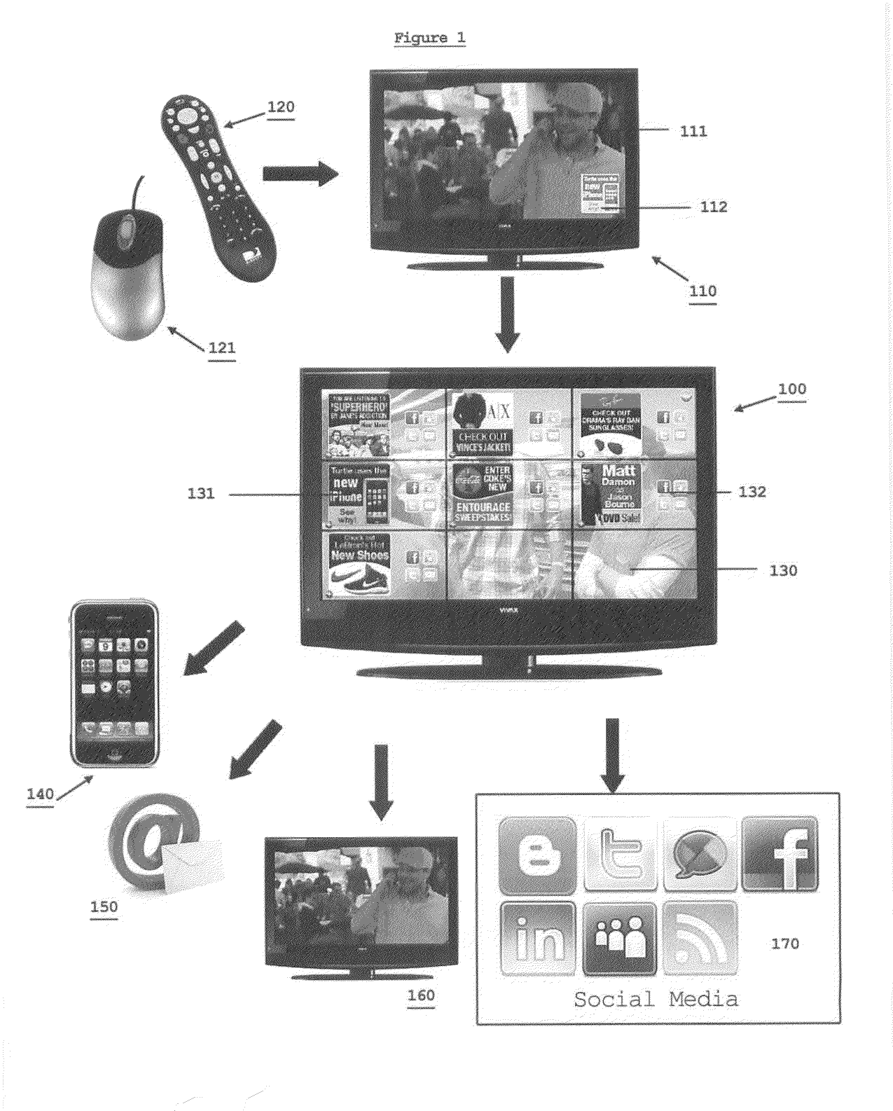

Beginning with FIG. 1, in one embodiment, the central physical component of the system 100, is a video display device 110. The video display device 110, displays video content 111 to the user of the system 100. The video display device 110 is typically a television, video projection system, computer system, tablet device, smartphone, or any device capable of displaying video content 111.

The system 100 can be hardware based, such as integrated into a television, cable box, satellite TV receiver, digital video recorder (e.g. Tivo™), video game system (e.g. Playstation™, Nintendo wii™), portable video game system (e.g. Nintendo DS™) digital media receiver (e.g. Apple TV™), smartphone (e.g. Android™, Blackberry™, iPhone™), computer based system (e.g. desktop pc, laptop pc, tablet computing device, PDA), or any hardware capable of displaying video content 111. Alternatively, the system 100 may be software based such that no hardware integration is required for operation of system 100. Such systems 100 are embedded in internet sites, Internet services, cable services, streaming video content services, or any other mechanism for displaying video content 111 (e.g. Netflix™, Hulu™, GoogleTV™, Vevo™, digital television network websites, cable services) and could be based on either custom software solutions or via means of displaying internet content well established in the art (e.g. Adobe™ Flash™, HTML, XML, CSS, JavaScript, VBScript). Video content 111 includes audio content with or without accompanying video such as exemplified by streaming audio services (e.g. Spotify™, Grooveshark™, Pandora™, Google Music™, Rdio™, or digital cable or satellite TV music channels).

The display device 110 displays advertisement overlays or “tags” 112 over video content 111. A tag 112 is any visual or audible or tactile notification to the user, typically a highlighted region, boxed region, flashing region, vibration, AdBug™, or any other indication that notifies the user that the video content 111 is tagged. Tags 112 appear over video content 111 in real-time for a duration designated by viewer preferences or alternatively by system 100 parameters not accessible by the viewer. Tags 112 highlight physical products, service, songs, persons, scenes, locations, or any video content 111 to which an advertiser wishes to direct a viewer's attention. Inclusion of a tag 112 does not preclude traditional forms of advertisement, such as commercial breaks and pre-roll ads. Commercial breaks may, however, also employ the use of tags 112. Advertisers and programmers utilize a software development kit (SDK) as a tool to tag 112 video content 111. The SDK ensures proper tag placement and timing. Tags are accompanied by metadata not limited to product/service type, genre, brand, scene, location, key words, demographic information, and user profile target parameters.

Users interact with the system 100, by reacting to tags 112 on the video display device 110. The user reacts using an input device 120, 121. Typical user interaction comprises using a remote control 120, computer mouse 121, infrared input device, radio frequency input device, Bluetooth™ input device, RFID device, touch-sensitive screen input, interacting with a motion sensing input device (e.g. Kinect™, iPhone™), or any other form of device input.

Upon user interaction to tags 112, the interaction is recorded by the system 100. The record of interaction is saved locally on the hardware used to access the system 100, and/or is saved remotely in a location accessible by the system 100. The user may access a user interface 130 to access the record of user interactions recorded by the system 100. The user interface 130 is text-based or a graphical user interface. The user interface 130 provides a means to indicate with which tags 112 a viewer has interacted by displaying a tag indication 131, which allows a user to access additional advertising materials.

Tag indications 131 are in icon form, photographic representations, audible cues, textual regions, menus, or any other means to indicate a tag 112 has been selected by the user.

It is possible to sort, delete, save, or send tag indications 131 to other-viewer user interfaces 130. The video content 111 does not need to be stopped or paused upon tag-prompted user interaction with the system 100, and the user may opt to continue viewing uninterrupted video content 111 without first accessing a user interface 130. When the user interface 130 is accessed by the user, the video content 111 may be paused while the user navigates the user interface 130, and upon exit from the user interface 130, the video content is available for continued viewing.

From within the user interface 130, advertising content is relayed to mobile media devices 140, email and traditional mail 150, video display devices 160, social media networks 170, and other digital, electronic, and communications means known or unknown in the art. This advertising content is relayed upon user interaction with controls 132 in the user interface 130 or without any active user interactions.

### User Profile Creation and Analysis

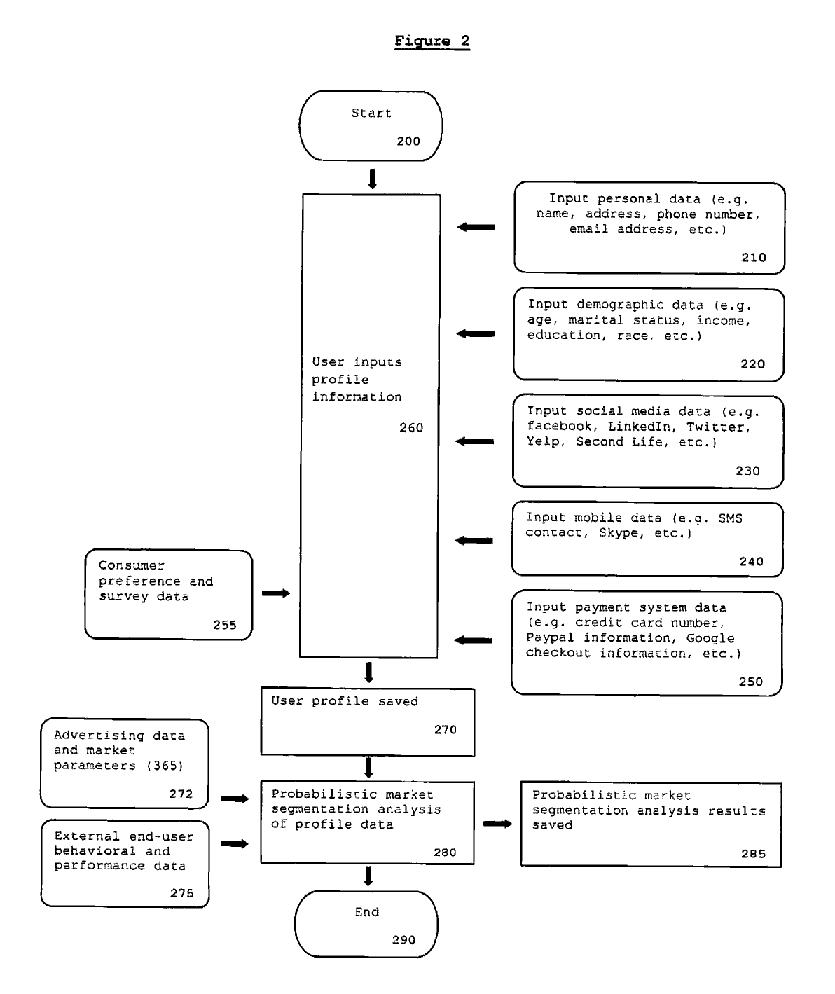

FIG. 2 shows how user profile information 260 may enter the system 100 and the general flow of data for market analyses 270, 272, 275, 280, 285. A user profile may be a compilation of information that may include personal data 210, demographic data 220, social media data, 230, mobile network data 240, payment data 250, consumer preference and survey data 255, or any other data known in the art to be relevant to user profiles and advertising. A user profile 260 is not necessary for the system 100 to function, but will augment calculations 280, 360 designed to target appropriate advertising content 365 to appropriate viewers.

Personal data 210 includes name, address, phone numbers, email addresses, or any other data used to describe or identify an individual user. Demographic data 220 includes age, marital status, income, educational information, race, ethnicity, religion, or any other personal information. Social media data 230 includes account login information, handles or usernames, social network preferences, or any other information related to social media use and accounts. Mobile and communication data 240 includes SMS contact information, geo-location data, voice over internet protocol (VoIP) information, or any other information related to mobile communications, communication technology, and related devices. Payment system data 250 includes credit card information or online payment system information or direct access to financial institutions such as Paypal™ or Google™ checkout, credit card accounts, bank accounts, credit card processors, electronic banking, or any other financial information or access. General survey data 255 includes shopping preferences, advertising preferences, buying habits, online purchasing behavior, brand awareness questions, customer satisfaction surveys, or any other consumer-related preference, behavior, habit, or survey data.

User behavioral data are associated with a user profile 260. These data include information related to recorded interactions with placed products, information about interactions from the user interface 130, how long users remain engaged with advertisements, how users share advertisements and information within their social network 170, what type of advertisements are being saved (or not being saved) for later viewing in the user interface 130, web browser or internet cookie information, geo-tag information from mobile devices, user contact lists, and other user behavior data known in the art to be useful for advertising purposes. User data are collected to calculate advertising cost per click, cost per mille, cost per engagement, cost per impression, cost per acquisition, and other advertiser cost metrics.

The system 100 saves user profile information 260 in a file or database, or may at an external location in a file or database electronically accessible by the system 100.

The system 100 utilizes user profile information 260 for probabilistic market segmentation analysis (PMSA) 280 and other marketing analytics. PMSA 280 encompasses the use of data and algorithms associated with advertising efforts. PMSA 280 includes the determining of appropriate target audiences, population segments, or individual users of the system 100 for particular advertising content. PMSA 280 includes the determining of advertisement timing, duration, version, content, tagging means, social media outlet choice, digital and electronic communication means choice, or any other advertising choice or strategy employed to maximize advertising efficacy known in the art.

Data provided by advertisers 272, user profile information from external users 275, external-user performance data 275, and other information known in the art to be useful for marketing analyses are also be utilized for PMSA 280.

Data provided by advertisers 272 includes market segment data, price discrimination data, customer retention data, regional market data, product differentiation data, and any other data known in the art utilized to improve marketing and advertising efficacy. These data are used to determine the type, frequency, and duration advertisements to be featured in a user interface 130, the type, frequency, and duration of tags 112, regionally specific advertisement choice, alternate and generic advertisement choice, communication modality choice, and any other choices known in the art made related to maximizing advertising or marketing efficacy.

User profile information from external users 275 includes all the same type of data collected for a local user to be saved in a local user profile 270 and described in detail above. External users include the body of users who access any aspect of the system 100, and includes users with a user profile 260, and those without.

External user performance data 275 includes information related to recorded user interactions with placed products, information from the user interface 130, how long users remain engaged with advertisements, how users share advertisements and information within their social network 170, and what type of advertisements are being saved (or not being saved) for later viewing, web browser or internet cookie information, geo-tag information from mobile devices, user contact lists, and other external user data or analyses known in the art to be useful for advertising purposes.

### Operation of the System

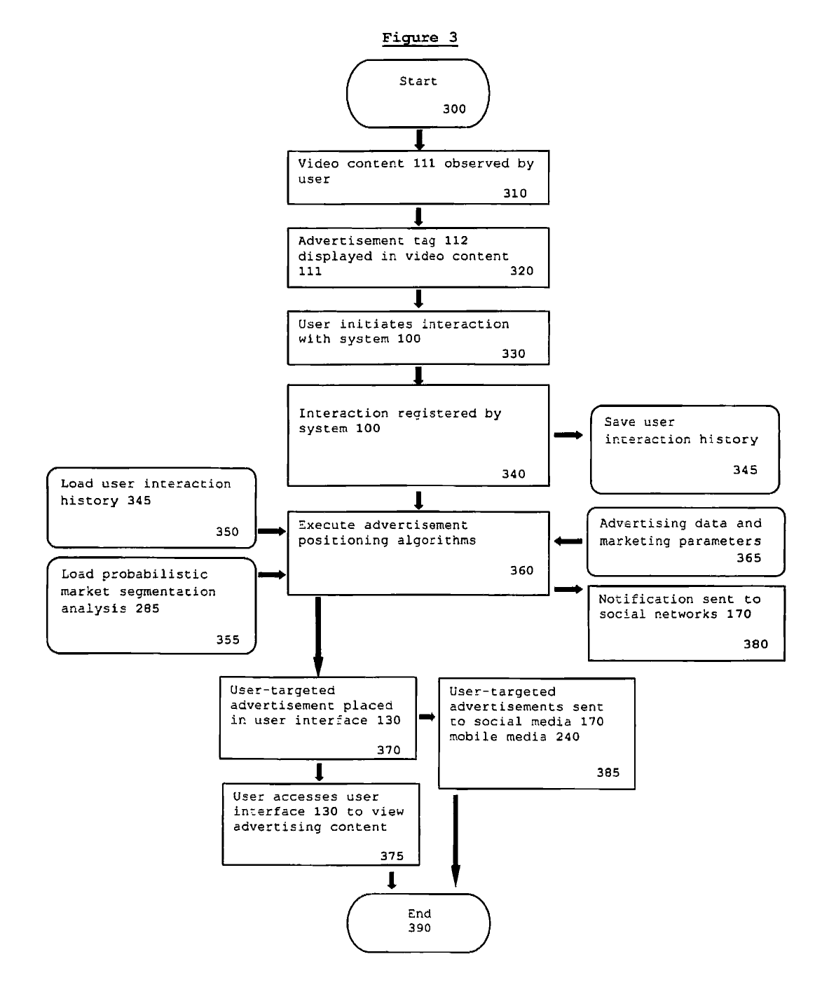

FIG. 3 is a detailed flow chart of one embodiment describing the operation of the system 100. In this preferred embodiment, the process begins when a user observes 310 video content 111 on a display device 110.

In conjunction with video content 111 interactive advertisements may be displayed 320 preferably in the form of tags 112. Displaying 320 tags 112 comprises visual means, audible means, tactile means, or via any other means indicating to a user that a tag 112 is present.

A user initiates an interaction 330 with the system 100 at a time point during or after a display device 110 displays 320 a tag 112. This user interaction 330 is registered 340 by the system 100, and a history of user interaction is saved 345 for marketing, advertising, or any related system 100 purposes.

Advertisement positioning algorithms 360 utilize saved user interaction history data 345, PMSA data 280, advertising content data 365 and marketing parameters 365, either separately or together, for use in any related system 100 purpose. Advertisement position algorithms 360 are utilized to calculate which particular tag indications 131 and associated advertising or marketing materials are accessible to a user in a user interface 130. Additionally, advertisement position algorithms 360 target particular advertising content 365 to particular users, user groups, demographic groups, social media networks 170, or mailing and distribution lists or any other advertising or marketing outlets known in the art. Notifications to social networks 170 are sent 380 either automatically or as a result of user interaction with controls 132 in the user interface 130. Notifications sent 380 to social networks 170 may be automated, customized, or manually entered messages or advertising materials, or may be popularity indicators such as “Like” notifications found on facebook™ or “+1” notifications found on Google™. From the user interface 130 controls 132, users relay actual advertising content 385 to social media networks 170 and mobile media 140 outlets.

After advertising content 365 is made accessible to a user in the user interface 130, a user navigates the user interface 130, views advertising content 375, and interacts with tag indications 131. Any input device known in the art is used for user navigation of the user interface.

### Method of Integrating Interactive Advertising Content

FIG. 3 provides, by way of example, a method of integrating interactive video content into real-time video content. The method begins when a user observes 310 video content 111. An advertisement tag 112 is then displayed 320 over the video content 111.

A user then initiates an interaction 330 with the system 100 as a reaction to the advertisement tag 112. This interaction 330 is then registered 340 and saved 345 by the system 100.

Advertising content is then prioritized through advertisement positioning algorithms 360. Advertisement positioning algorithms load 350 user interaction history into the system 100. Additionally the system 100 loads 355 probabilistic market segmentation analysis 285 for use by advertisement positioning algorithms. The system 100 also loads 365 advertising data and marketing parameters for use by advertisement positioning algorithms.

Notifications are then automatically sent 380 to social networks 170. User-targeted advertisements are also placed 370 in the user interface 130. A user then accesses the user interface 130 to view 375 a tag indication 131 which allows a viewer to access additional advertising material. Advertising content is then sent 385 by the user from the user interface 130 by interacting with controls 132 found therein.

### Region-Based Advertisement Selection

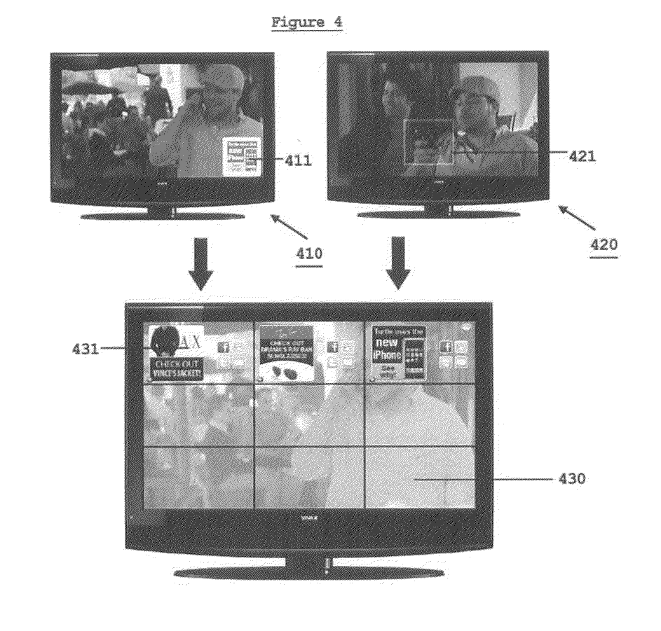

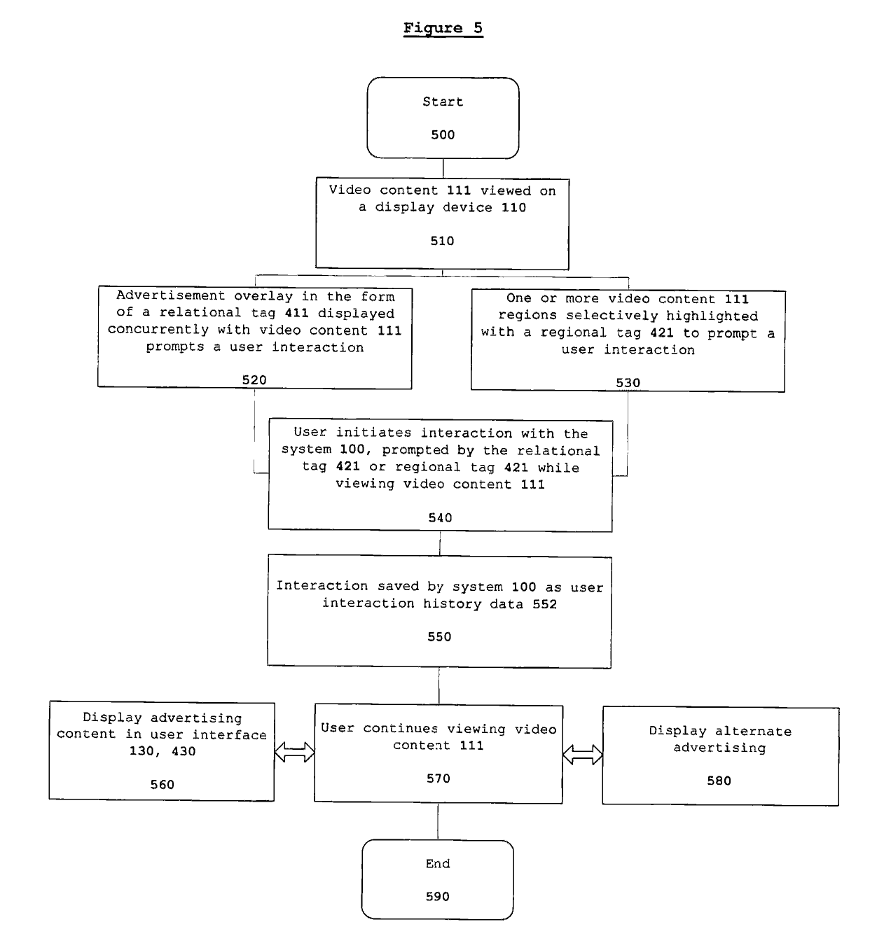

FIGS. 4 and 5 describe the preferred embodiment of region-based advertising on the system 100. FIG. 4 shows variations of advertisement tags 112 displayed over video content 111 on a display device 110, specifically, relational tags 411 and regional tags 421. In one embodiment 410, a relational tag 411 is displayed, the content of which directly relates to the substance of the video content 111 shown on a display device 110. For example, if the video content 111 included a depiction of an actor using a particular model of cellular telephone, the relational tag 411 in this particular case could be an advertisement for that particular model of cellular telephone. The use of a relational tag 411 is not limited to physical products, but extends to advertising efforts related to music, services, actors, scene locations, scene dialogue, or any other video content 111 shown on a display device 110 for which advertising or marketing is appropriate.

In another embodiment 420, a regional tag 421 is displayed, highlighting a particular region of the video content 111. In this embodiment 420, the regional tag 421 is any visual or audible or tactile notification to the user, typically a highlighted region, boxed region, circumscribed region, flashing region, or any other indication or combination of indications that notifies the user that a particular portion of the video content 111 is tagged. Regional tags 421 highlight physical products, service, songs, persons, scenes, locations, or any video content 111 to which an advertiser or marketer wishes to direct a viewer's attention. For example, if the video content 111 includes a depiction of an actor using a particular model of cellular telephone, the regional tag 421 in this particular case highlights a box around the cellular telephone. As the actor's hand, and therefore phone, moves on the screen, the regional tag 421 tracks that same motion path, therefore continually highlighting the cellular telephone.

A user interacts with relational tags 411 or regional tags 421 in the same way by which interactions with tags 112 in general occur. Upon user interaction to relational tags 411 or regional tags 421, the system 100 records the interaction. The record of interaction is saved locally on the hardware used to access the system 100, or additionally/alternatively saved remotely in a location accessible by the system 100. The user accesses a user interface 130, 430 to access the record of user interactions recorded by the system 100. The user interface 130, 430 is either a text-based or a graphical user interface. The user interface 130, 430 provides a means to indicate a user interaction with the system 100 in response to a relational tag 411 or regional tag 421. The user interface 130, 430 displays a tag indication 131, 431 which notifies a user of the option to access additional advertising materials. Tag indications 131, 431 are in icon form, photographic representations, audible cues, textual regions, menus, or any other means to indicate a tag 112 is available for selection by the user. Tag indications 131, 431 may be sorted, deleted, saved, or sent to other-viewer user interfaces 130, 430. The video content 111 need not be stopped or paused upon tag-prompted user interaction with the system 100, and the user has the option continue to view uninterrupted video content 111 without first accessing a user interface 130, 430. Tag indications 131, 431 are viewed in the user interface 130, 430 at a time point after initial display of either a relational tag 411 or regional tag 421. The video content 111 does not need to be stopped or paused upon a tag-prompted user interaction with the system 100, and the user may continue to view uninterrupted video content 111 without first accessing a user interface 130, 430.

### Region-Based Advertisement Selection

FIG. 5 is a detailed flow chart describing one embodiment of region-based advertising on the system 100. In this preferred embodiment, the process begins when a user views 510 video content 111 on a display device 110.

In conjunction with video content 111, interactive advertisements are displayed 520, 530 preferably in the form of relational tags 411 or regional tags 421.

At a time point during or after a relational tag 411 or regional tag 421 is displayed 520, 530 on a display device 110, a user initiates an interaction 540 with the system 100.

This user interaction 540 is registered and saved 550 for marketing, advertising, or any related system 100 purposes. This interaction is saved 550 as user interaction history data 552.

Saved user interaction history data 552 is utilized separately or in conjunction with PMSA data 280 which is utilized separately or in conjunction with advertising content data 365 and marketing parameters 365 for use in advertisement positioning algorithms 360, or for any related system 100 purposes. Advertisement position algorithms 360 are utilized to calculate which particular tag indications 131, 431 and associated advertising or marketing materials are accessible to a user in a user interface 130, 430. This occurs in the system 100 without a user interrupting viewing content 111. A user therefore continually watches video content 570 without entering the user interface 130, 430.

Advertisement position algorithms 360 target particular advertising content 365 to particular users, user groups, demographic groups, social media networks 170, or mailing and distribution lists or any other advertising or marketing outlets known in the art. Such advertising content is viewed 560 in the user interface 130, 430.

Although advertisement position algorithms 360 target particular advertising content 365 to particular users, user groups, demographic groups, social media networks 170, or mailing and distribution lists or any other advertising or marketing outlets known in the art, alternative advertisements nonetheless populate the user interface 130, 430. Alternative advertisements include advertisements for generic products, substitute goods known to be popular in a user's particular market, local business advertising, competitor's advertising, advertising for complimentary goods or services, or combinations thereof. For example, if a drug company's pharmaceutical is featured in video content, advertising content for a generic version of the pharmaceutical could alternatively populate the user interface 130, 430.

### Method of Providing Interactive Region-Based Video Advertising

FIG. 4 provides, by way of example, a method of integrating interactive region-based video advertising into real-time video content. The method begins when a user observes 310 video content 111. An advertisement tag 112, 411, 421 is then displayed 320 over the video content 111.

In one embodiment 410, a relational tag 411 is displayed, the content of which directly substantively relates to the video content 111 shown on a display device 110. The use of a relational tag 411 comprises product promotion, promotions related to music, services, actors, scene locations, scene dialogue, or any other video content 111 shown on a display device 110 for which advertising or marketing would be appropriate.

In another embodiment 420, a regional tag 421 is displayed, highlighting a particular region of the video content 111. In this embodiment 420, the regional tag 421 is any visual or audible or tactile notification to the user, typically a highlighted region, boxed region, flashing region, or any other indication or combination of indications that notifies the user that a particular portion of the video content 111 is tagged. Regional tags 421 highlight physical products, services, songs, persons, scenes, locations, or any video content 111 to which an advertiser or marketer wishes to direct a viewer's attention.

A user may then initiate an interaction 330 with the system 100 as a reaction to the relational tag 411 or regional tag 421. This interaction 330 is then registered 340 and saved 345 by the system 100.

Advertising content is then prioritized through advertisement positioning algorithms 360. User interaction history 345 may be loaded 350 in the system 100 for use by advertisement positioning algorithms. Additionally, probabilistic market segmentation analysis 285 is loaded 355 in the system 100 for use by advertisement positioning algorithms. Advertising data and marketing parameters are also loaded 365 in the system 100 for use by advertisement positioning algorithms.

Notifications are then automatically sent 380 to social networks 170. User-targeted advertisements are also be placed 370 in the user interface 130, 430. A user then accesses the user interface 130, 430 to view 375 a tag indication 131, 431 which allows a viewer to access additional advertising material. Advertising content is sent 385 by the user from the user interface 130, 430 by interacting with controls 132 found therein.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A system for interactive video advertising, the system comprising:
a video display capable of displaying video content;
an advertisement tag that overlays the video content, wherein the advertisement tag substantively relates to the video content;
a user interaction that is prompted by the advertisement tag;
a registry of interaction history of the user interaction;
an interaction history archive, in the form of an advertising cart user interface, that allows the population and temporal storage of the interaction history;
an advertisement positioning algorithm that reviews and prioritizes the interaction history created by a user acknowledgment of the advertisement tag;
means for allowing probabilistic market segmentation analysis in order to display advertising content based upon the interaction history; and
distribution means for disseminating advertising content.

2. The system for interactive video advertising of claim 1, wherein the advertisement tag substantively relates to at least one of a product, service, song, person, scene, and location.

3. The system for interactive video advertising of claim 1, wherein the advertisement tag comprises at least one of a photographic representation, icon, logo, textual representation, menu, tactile representation, and audible notification.

4. The system for interactive video advertising of claim 1, wherein the advertisement tag contains embedded metadata.

5. A system for interactive video advertising, the system comprising:
a video display capable of displaying video content;
an advertisement tag that overlays video content, wherein the advertisement tag regionally relates to the video content;
a user interaction that is prompted by the advertisement tag;
a registry of interaction history;
an interaction history archive, in the form of an advertising cart user interface, that allows the population and temporal storage of the interaction history;
an advertisement positioning algorithm that reviews and prioritizes the interaction history created by a user acknowledgment of the advertisement tag;
means for allowing probabilistic market segmentation analysis in order to display advertising content based upon the interaction history which was temporarily stored; and
distribution means for disseminating advertising content.

6. The system for interactive video advertising of claim 5, wherein the advertisement tag indicates at least one of a product, service, person, scene, and location.

7. The system for interactive video advertising of claim 5, wherein the advertisement tag comprises at least one of a highlighted region, boxed region, circumscribed region, flashing region, tactile notification, and audible notification.

8. The system for interactive video advertising of claim 5, wherein the advertisement tag contains embedded metadata.

9. The system for interactive video advertising of claim 5, wherein the advertisement tag is dynamic.

10. The system for interactive video advertising of claim 9, wherein the advertisement tag tracks the video content.

11. A method for interactive video advertising, the method comprising the steps of:
displaying video content on a video display wherein an advertisement tag is displayed in conjunction with said video content;
substantively relating an advertisement tag the with the video content;
interacting with the video display thereby populating an interaction history archive with a record of such interaction;
associating the record of interaction with advertising content;
prioritizing the advertising content based on user preferences, user history, advertising data, marketing parameters, market segmentation analysis, or combinations thereof;
storing the prioritized advertising content in a user interface;
accessing the user interface in order to adjust user interface settings or controls; and
distributing the advertising content to other individuals or networks.

12. The method for interactive video advertising according to claim 11, wherein;
the relating of the video content with the advertisement tag comprises at least one of regionally highlighting, regionally boxing, regionally circumscribing, regionally flashing, tactilely indicating, and audibly indicating a relationship between the advertisement tag and a particular region of the video content.
